(19) United States
(12) Patent Application Publication
(10) Pub. No.: US 2026/0278368 A1
(43) Pub. Date: Sep. 17, 2026

(54) CLUSTERING DEVICE, CLUSTERING METHOD, AND RECORDING MEDIUM

(71) Applicant: NEC Corporation, Tokyo (JP)

(72) Inventors: Kensuke WAGATA, Tokyo (JP); Chenhui HUANG, Tokyo (JP); Fumiyuki NIHEY, Tokyo (JP)

(73) Assignee: NEC Corporation, Tokyo (JP)

(21) Appl. No.: 19/460,571

(22) Filed: Jan. 27, 2026

(30) Foreign Application Priority Data
Mar. 14, 2025 (JP) 2025-040981

(51) Int. Cl. G06N 3/08

(52) U.S. Cl. CPC G06N 3/08

(57) ABSTRACT

In the clustering device, the feature extractor extracts a data feature from input data. The loss calculation unit calculates a loss value that maximizes the similarity of the data feature to the nearest cluster feature and minimizes the similarity of the data feature to the cluster features other than the nearest cluster feature. The update unit updates the parameters of the feature extractor and the multiple cluster features based on the loss value. The clustering unit determines a cluster to which the input data belongs, based on the similarity between the data feature and the multiple cluster features. It is possible to optimize prediction of a disease risk by predicting the disease risk using a prediction model suitable for a cluster determined by a clustering device. Also, by the disease risk prediction, it is possible to assist the subject's health-related decision making.

### INCORPORATION BY REFERENCE

This application is based upon and claims the benefit of priority from Japanese Patent Application 2025-040981, filed on Mar. 14, 2025, the disclosure of which is incorporated herein in its entirety by reference.

### TECHNICAL FIELD

The present disclosure relates to a clustering method.

### BACKGROUND ART

In recent years, with the increasing importance of preventive medicine, techniques for analyzing big data such as medical examinations have been actively developed. For example, JP 2022-146822 A discloses an image diagnosis system that estimates a diagnosis result using a machine learning model based on an input image.

### SUMMARY

Clustering is known as a method of dividing a large number of medical examinees into groups having the same properties when analyzing health of medical examinees such as medical examinations. However, when a large amount of complex data such as medical examination data is used, it is difficult to find a potential cluster having a property unique to each group by a general clustering method.

One object of the present disclosure is to provide a clustering method capable of finding a potential cluster having a unique property even in a complex data structure.

According to an example aspect of the present invention, there is provided a clustering device comprising:
a feature extractor that extracts a data feature from input data;
a loss calculation means configured to calculate a loss value that maximizes a similarity of the data feature to a nearest cluster feature and minimizes a similarity of the data feature to a cluster feature other than the nearest cluster feature;
an update means configured to update parameters of the feature extractor and a plurality of the cluster features based on the loss value; and
a clustering means configured to determine a cluster to which the input data belongs, based on the similarity between the data feature and the plurality of cluster features.

According to another example aspect of the present invention, there is provided a clustering method executed by a computer, the clustering method comprising:
extracting a data feature from input data using a feature extractor;
calculating a loss value that maximizes a similarity of the data feature to a nearest cluster feature and minimizes a similarity of the data feature to a cluster feature other than the nearest cluster feature;
updating parameters of the feature extractor and a plurality of the cluster features based on the loss value; and
determining a cluster to which the input data belongs, based on the similarity between the data feature and the plurality of cluster features.

According to still another example aspect of the present invention, there is provided a program causing a computer to execute:
extracting a data feature from input data using a feature extractor;
calculating a loss value that maximizes a similarity of the data feature to a nearest cluster feature and minimizes a similarity of the data feature to a cluster feature other than the nearest cluster feature;
updating parameters of the feature extractor and a plurality of the cluster features based on the loss value; and
determining a cluster to which the input data belongs, based on the similarity between the data feature and the plurality of cluster features.

According to the present disclosure, it is possible to find a potential cluster having a unique property even in a complex data structure.

### BRIEF DESCRIPTION OF THE DRAWINGS

FIG. 1 illustrates an overall configuration of a clustering device according to the present disclosure;

FIG. 2 is a block diagram illustrating a hardware configuration of the clustering device;

FIG. 3 is a block diagram illustrating a functional configuration of the clustering device at the time of training;

FIG. 4 is a diagram conceptually describing a loss value;

FIGS. 5A to 5C are diagrams illustrating a method of updating by an update unit;

FIG. 6 is a flowchart of training processing;

FIG. 7 is a block diagram illustrating a functional configuration of the clustering device at the time of inference;

FIG. 8 is a flowchart of inference processing;

FIG. 9 illustrates a schematic configuration of a disease risk prediction device to which the clustering device is applied;

FIG. 10 is a block diagram illustrating a configuration of another clustering device according to the present disclosure; and

FIG. 11 is a flowchart of processing by the another clustering device.

### EXAMPLE EMBODIMENTS

Hereinafter, preferred example embodiments of the present disclosure will be described with reference to the drawings.

### First Example Embodiment

### (Overall Configuration)

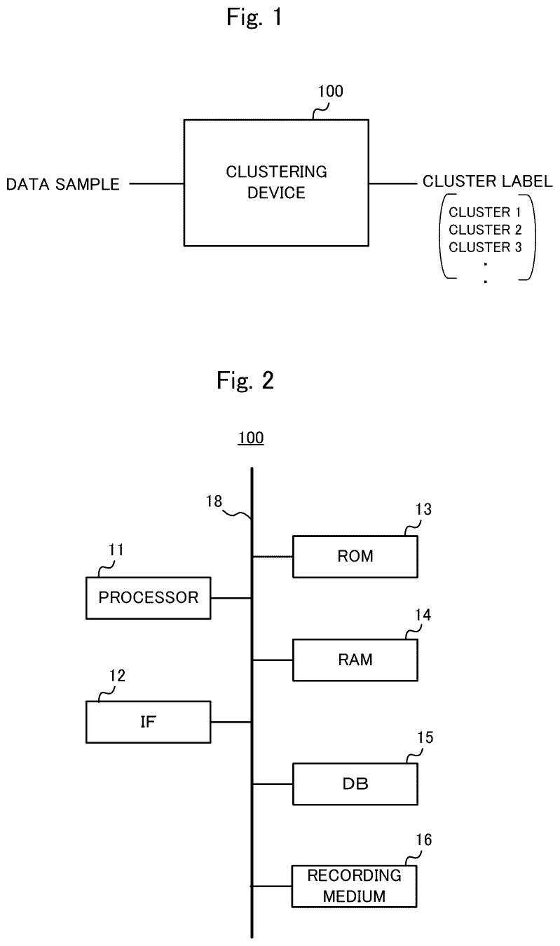

FIG. 1 illustrates an overall configuration of a clustering device according to the present disclosure. A clustering device 100 clusters input data samples and outputs cluster labels. For example, data samples related to health of a subject are input to the clustering device 100. The data samples include, for example, various pieces of data obtained by a medical examination or the like, such as height, weight, sex, blood pressure, body mass index (BMI), body fat percentage, neutral fat value, smoking status and amount, drinking status and amount, and the like of the subject. Note that, the data samples may be multimodal data, that is, multiple pieces of data among the above.

A cluster label is a label indicating one of multiple clusters. The clustering device 100 outputs a cluster label indicating a cluster, to which an input data sample belongs, among the multiple clusters. The cluster label includes cluster identification information, and is expressed as, for example, “cluster 1”, “cluster 2”, or the like.

### (Hardware Configuration)

FIG. 2 is a block diagram illustrating a hardware configuration of the clustering device 100. As illustrated, the clustering device 100 includes a processor 11, an interface (IF) 12, a read only memory (ROM) 13, a random access memory (RAM) 14, a database (DB) 15, and a recording medium 16. The components are connected through, for example, a bus 18.

The processor 11 is a computer such as a central processing unit (CPU), and controls the entire clustering device 100 by executing a program prepared in advance. Specifically, as the processor 11, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used.

In addition, the processor 11 loads a program stored in the ROM 13 or the storage medium 16 into the RAM 14 and executes each process coded in the program. The processor 11 functions as a part or all of the clustering device 100. Specifically, the processor 11 executes training processing and inference processing to be described later.

The IF 12 transmits and receives data to and from an external device. Specifically, at the time of training, the clustering device 100 receives a data sample as training data through the IF 12. Meanwhile, at the time of inference, the clustering device 100 receives a data sample to be inferred through the IF 12, and outputs a cluster label obtained by the inference to a storage device or the external device.

The ROM 13 stores various programs to be executed by the processor 11. The RAM 14 is used as a working memory during execution of various types of processing by the processor 11.

The DB 15 stores various algorithms, data, machine learning models, deep learning models, and the like used when the clustering device 100 executes training processing and inference processing to be described later.

The recording medium 16 is a non-volatile and non-transitory recording medium such as a disk-shaped recording medium or a semiconductor memory. The recording medium 16 may be detachably attached to the clustering device 100. The recording medium 16 records various programs to be executed by the processor 11.

In addition to the above, the clustering device 100 may include a display device such as a liquid crystal display and an input device such as a keyboard and a mouse. The display device and the input device are used by, for example, an operator of the clustering device 100.

### (Functional Configuration During Training)

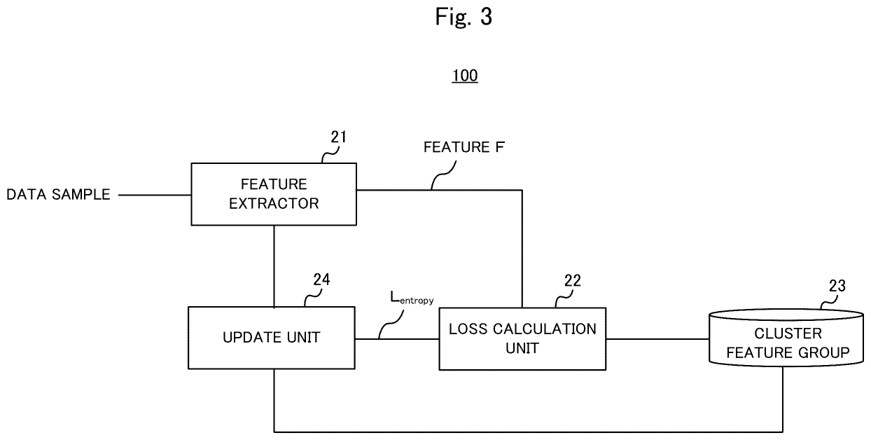

FIG. 3 is a block diagram illustrating a functional configuration of the clustering device 100 at the time of training. The clustering device 100 at the time of training includes a feature extractor 21, a loss calculation unit 22, a cluster feature group 23, and an update unit 24. At the time of training, the feature extractor 21 and the cluster feature group 23 are optimized using a data sample as training data.

The feature extractor 21 is configured by, for example, a deep neural network, and extracts a feature F from the input data sample. The extracted feature F can be, for example, a 128 dimensional vector. The feature extractor 21 outputs the extracted feature F to the loss calculation unit 22. The feature F extracted from the data sample is an example of a data feature.

The cluster feature group 23 stores a feature of a cluster (hereinafter referred to as a “cluster feature”) for each of multiple clusters. Each cluster feature indicates the center of gravity of each cluster, and includes a vector having the same number of dimensions as the feature F and a cluster label associated with the cluster. For example, in a case where the number of clusters is set to “3” in advance, three cluster features and cluster labels 1 to 3 associated with the cluster features are stored in the cluster feature group. As will be described later, each cluster feature is initialized by a random value at the start of training.

The loss calculation unit 22 calculates a loss value based on the feature F extracted by the feature extractor 21 and each cluster feature included in the cluster feature group 23. Specifically, the loss calculation unit 22 calculates a loss value having the following purposes.
(A) Similarity of the feature F with respect to the cluster feature having the highest similarity with the feature F is maximized.
(B) Similarity of the feature F with respect to other cluster features is minimized.

Specifically, the loss calculation unit 22 calculates, as a loss value, an entropy of the probability that the feature F belongs to each cluster. As an example, the loss calculation unit 22 converts the similarity (L2 distance) between the feature F and each cluster feature into a probability distribution using a softmax function, and calculates an entropy for the obtained probability distribution as a loss value. A loss value (loss function) L_{entropy} in this case is expressed by the following formula.

$${L}_{entropy} = H ( softmax ( - {‖ {z}_{e} - {e}_{i} ‖}_{2} )$$

$${z}_{e} is feature$$

$${e}_{i} is cluster feature of cluster i$$

In the process of minimizing this loss value during training, the similarity of the feature F with respect to one cluster feature is maximized while the similarity thereof with respect to other cluster features is minimized.

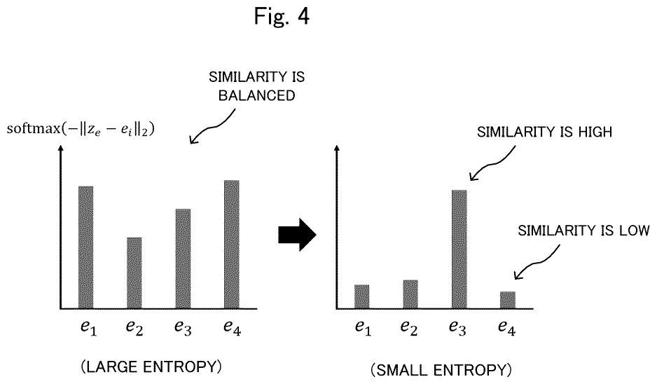

FIG. 4 is a diagram conceptually describing the loss value L_{entropy}. Now, there are four clusters 1 to 4, and their cluster features are set as e₁ to e₄. A feature of an input data sample is indicated by zₑ. FIG. 4 illustrates a probability distribution obtained by converting the similarity between the feature zₑ and each of the cluster features e₁ to e₄ in this case using the softmax function. As illustrated in the graph on the left side of FIG. 4, in a case where the similarity between the feature of the input data sample and each cluster feature is relatively balanced, the entropy increases and the loss value L_{entropy} becomes large. On the other hand, as illustrated in the graph on the right side of FIG. 4, in a case where the similarity between the feature of the input data sample and one cluster feature is high and the similarity between the feature of the input data sample and other cluster features are low, the entropy decreases and the loss value L_{entropy} becomes small. Therefore, by training the clustering device 100 in such a way as to reduce the loss value L_{entropy}, it is possible to achieve the above purposes (A) and (B). The loss calculation unit 22 outputs the calculated loss value L_{entropy} to the update unit 24.

The update unit 24 updates the parameters of the feature extractor 21 and the cluster features included in the cluster feature group 23 in such a way as to minimize the loss value L_{entropy}. Here, the update unit 24 gradually updates the parameters of the feature extractor 21 and the cluster features. In one example, the update unit 24 updates the parameters of the feature extractor 21 by an update for the first time (which is also referred to as a “first update”), and updates the cluster features by an update for the second time (which is also referred to as a “second update”).

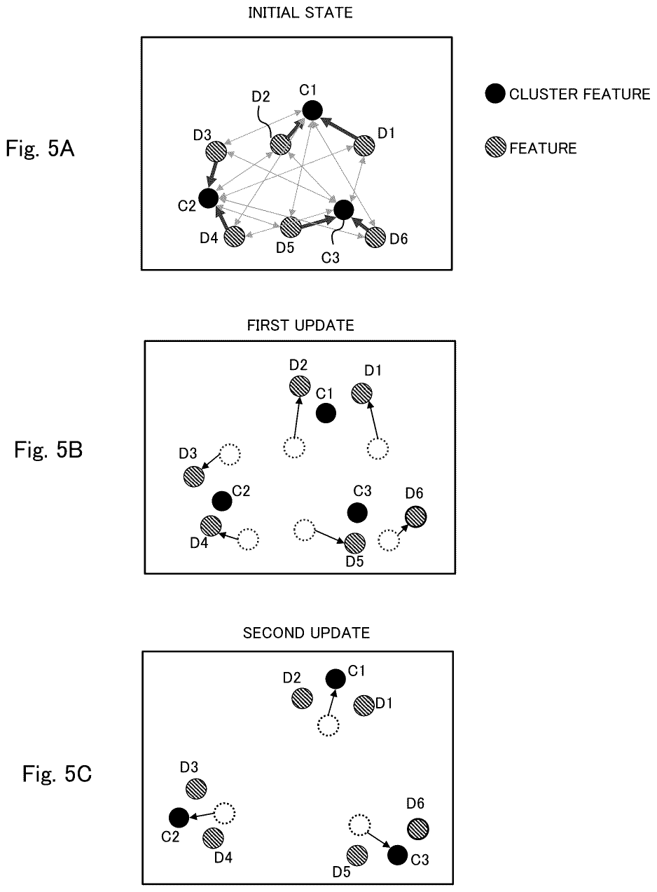

FIGS. 5A to 5C are diagrams illustrating a method of updating by the update unit 24. FIGS. 5A to 5C indicate examples in which cluster features C (C1 to C3) and data features D (D1 to D6) are mapped to one feature space. FIGS. 5A to 5C indicate that the closer the distance between the features in the feature space, the higher the similarity between the features.

FIG. 5A indicates positions, in the feature space, of the cluster features C1 to C3 and the data features D1 to D6 in the initial state. In the first update, the update unit 24 updates the parameters of the feature extractor 21 according to the above-described purposes (A) and (B). Specifically, for each data feature D, the update unit 24 updates the parameters of the feature extractor 21 in such a way that the similarity of the data feature with respect to the nearest cluster feature C is maximized and the similarity of the data feature with respect to other cluster features Cis minimized. In other words, in the feature space, the parameters of the feature extractor 21 are updated in such a way that each data feature D approaches the nearest cluster feature C and moves away from other cluster features C. As a result, each data feature D moves in the feature space as illustrated in FIG. 5B. In FIG. 5B, the position of the data feature D before the movement is indicated by a broken line circle, and the movement is indicated by an arrow. In FIG. 5B, for example, the data features D1 and D2 move in such a way as to approach the nearest cluster feature C1 and move away from other cluster features C2 and C3. Other data features D3 to D6 similarly move in such a way as to approach the nearest cluster feature C and move away from other cluster features C.

Next, in the second update, the update unit 24 updates each cluster feature. Specifically, the update unit 24 updates each cluster feature in such a way as to reduce the similarity of the cluster feature with other cluster features while keeping the similarity of the cluster feature with the nearest data feature. In other words, in the feature space, the update unit 24 updates each cluster feature in such a way that the cluster feature moves away from other cluster features while keeping the distance from the nearest data feature. As a result, each cluster feature C moves in the feature space as illustrated in FIG. 5C. In FIG. 5C, the position of the cluster feature C before the movement is indicated by a broken line circle, and the movement is indicated by an arrow. For example, the cluster feature C1 is updated in such a way as to move away from other cluster features C2 and C3 while keeping the distance from the nearest data feature D1. The cluster features C2 and C3 are similarly updated in such a way as to move away from other cluster features C while keeping the distance from the nearest data feature D.

In this way, by performing the two updates, i.e., the first and second updates, the distribution of clusters is clearly differentiated from the initial state, so that the properties unique to the respective clusters are more clearly expressed. Note that, the update unit 24 may set the above-described two updates as one cycle, and repeat updating for multiple cycles as necessary. In the above example, the parameters of the feature extractor 21 are updated in the first update and the cluster feature is updated in the second update, but the order may be swapped. In other words, the update unit 24 may update the cluster feature in the first update and update the parameters of the feature extractor 21 in the second update.

### (Training Processing)

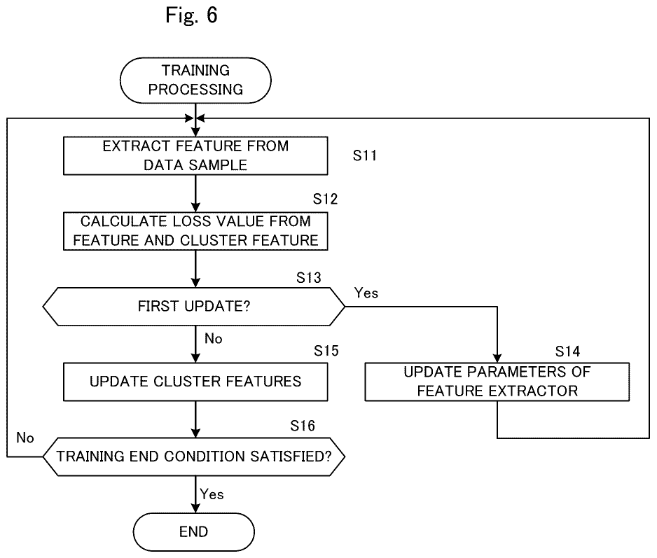

Next, training processing of the clustering device 100 will be described. FIG. 6 is a flowchart of the training processing. This processing is achieved by the processor 11 illustrated in FIG. 2 executing a program prepared in advance and operating as each component illustrated in FIG. 3. Note that, as a premise, a random value is set as an initial value of the cluster feature for a predetermined number of clusters included in the cluster feature group 23.

First, upon input of a data sample as training data, the feature extractor 21 extracts the feature F from the data sample (step S11). Next, the loss calculation unit 22 calculates a loss value based on the extracted feature F and each cluster feature included in the cluster feature group 23 (step S12). Next, the update unit 24 determines whether it is the first update (step S13). If the update is the first update (step S13: Yes), the update unit 24 updates the parameters of the feature extractor 21 by the method described above (step S14), and the process returns to step S11. The first update is performed in this manner.

When the first update is completed, the process returns to step S11, and the feature extractor 21 extracts the feature F from the data sample (step S11). At this time, the feature extractor 21 extracts the feature F from the data sample using the parameters updated in step S14. When the process returns to step S11 after the first update is completed, the data sample from which the feature is extracted by the feature extractor 21 is preferably the same data sample from which the feature F is extracted by the feature extractor 21 at the time of the first update.

Next, the loss calculation unit 22 calculates a loss value based on the extracted feature F and each cluster feature included in the cluster feature group 23 (step S12). Next, the update unit 24 determines whether it is the first update (step S13). In this case, since the first update has been completed (step S13: No), the update unit 24 updates the cluster features by the method described above (step S15). The second update is performed in this manner.

Next, the update unit 24 determines whether the predetermined training end condition is satisfied (step S16). The training end condition includes, for example, completion of training processing using a predetermined number of data samples prepared in advance, reduction of the loss value to a predetermined value, and the like, and any condition can be set as the training end condition. In this way, the update for one cycle including the first update and the second update is repeated multiple times until a predetermined training end condition is satisfied. Then, when the predetermined training condition is satisfied (step S16: Yes), the training processing ends. As a result, the parameters of the feature extractor 21 and the cluster features included in the cluster feature group 23 are optimized.

### (Functional Configuration During Inference)

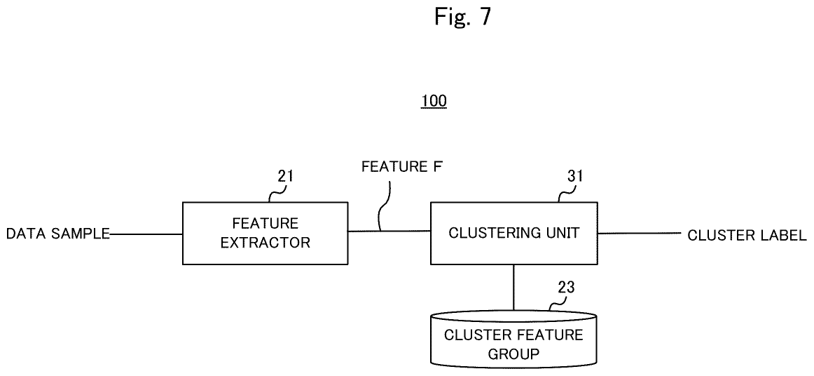

FIG. 7 is a block diagram illustrating a functional configuration of the clustering device 100 at the time of inference. The inference refers to processing of clustering target data samples using the trained clustering device 100. The clustering device 100 at the time of training includes the feature extractor 21, the cluster feature group 23, and a clustering unit 31. Here, as the parameters of the feature extractor 21 and each cluster features included in the cluster feature group 23, those optimized by the above training processing are used.

The feature extractor 21 extracts the feature F from the target data sample and outputs the feature F to the clustering unit 31. The clustering unit 31 determines a cluster feature having the highest similarity to the input feature F among multiple clusters included in the cluster feature group 23. As the similarity at this time, for example, cosine similarity, L1 distance, L2 distance, and the like can be used. Then, the clustering unit 31 outputs a cluster label associated with the determined cluster feature. In this way, the cluster to which the data sample to be inferred belongs is determined.

### (Inference Processing)

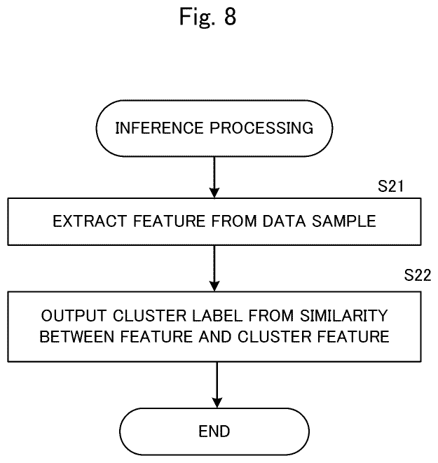

Next, inference processing by the clustering device 100 will be described. FIG. 8 is a flowchart of the inference processing. This processing is achieved by the processor 11 illustrated in FIG. 2 executing a program prepared in advance and operating as each component illustrated in FIG. 7. As a premise, the parameters of the feature extractor 21 and each cluster feature of the cluster feature group 23 optimized by the above training processing are used.

First, upon input of a data sample to be inferred, the feature extractor 21 extracts the feature F from the data sample (step S21). Next, the clustering unit 31 outputs a cluster label associated with a cluster feature having the highest similarity to the input feature F among the multiple clusters included in the cluster feature group 23 (step S22). The inference processing then ends. As described above, by clustering using the feature extractor 21 and the cluster features optimized by the training processing, it is possible to perform clustering based on the unique property of each cluster.

### EXAMPLE

Next, an example of the training processing and the inference processing using the clustering device 100 will be described. In this example, data related to health of the subject, such as medical examination data, is input as the data sample. The data related to health of the subject includes, for example, various pieces of data obtained by medical examinations or the like, such as height, weight, sex, blood pressure, BMI, body fat percentage, neutral fat value, smoking status and amount, drinking status and amount, and the like of the subject.

At the time of training, an input data sample input to the feature extractor 21 corresponds to training data, and is a tensor of the input data sample=(the number of samples×the number of medical examination items). The number of samples corresponds to the number of subjects of the medical examination used as the training data. The feature extractor 21 converts a vector of the number of medical examination items included in the input data sample into a vector of the number of dimensions of the feature, and outputs a tensor of the feature F=(the number of samples×the number of dimensions of the feature). On the other hand, the cluster feature group 23 is a tensor of (the number of clusters×the number of dimensions of the feature). An initial value of the cluster feature is set to a random value as described above.

The loss calculation unit 22 calculates a loss value based on the similarity between the feature F and each cluster feature included in the cluster feature group 23. Then, the update unit 24 updates the parameters of the feature extractor 21 and the cluster features included in the cluster feature group in such a way as to minimize the loss value.

At the time of inference, a tensor of a data sample to be inferred=(the number of samples×the number of medical examination items) is input. The trained feature extractor 21 converts a vector of the number of medical examination items into a vector of the number of dimensions of the feature, and outputs a tensor of the feature F=(the number of samples×the number of dimensions of the feature). The clustering unit 31 determines a cluster to which the data sample to be inferred belongs based on the similarity between the extracted feature F and the multiple cluster features, and outputs the cluster label.

### Application Example

Next, an application example of the clustering device of the present disclosure will be described. The clustering device 100 can be suitably applied to the medical or healthcare field. For example, the clustering device 100 can be used when a risk of a disease or a lifestyle disease is estimated based on data obtained in a periodic medical examination.

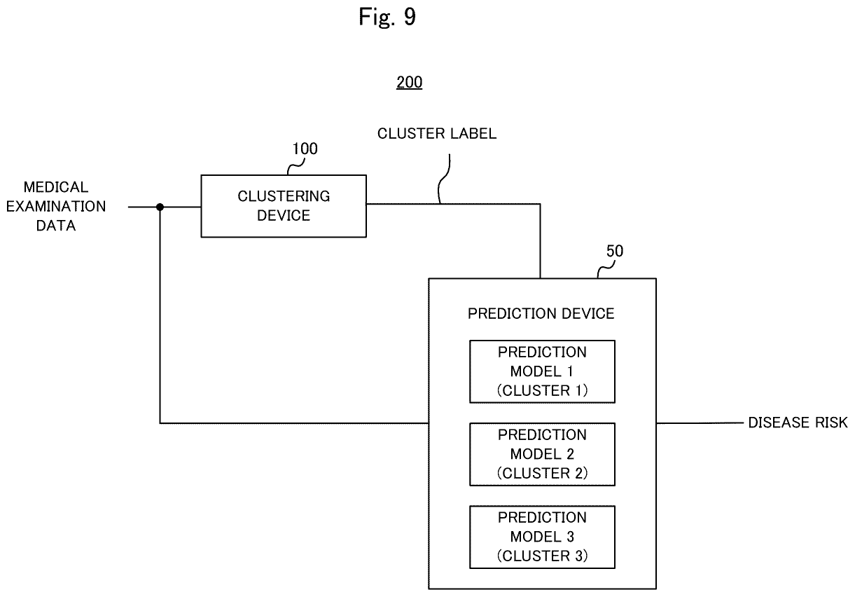

FIG. 9 illustrates a schematic configuration of a disease risk prediction device to which the clustering device 100 of the present disclosure is applied. A disease risk prediction device 200 estimates a disease risk based on medical examination data. The disease risk prediction device 200 includes the above clustering device 100 and a prediction device 50.

The clustering device 100 performs clustering based on the medical examination data. The medical examination data includes, for example, various pieces of data obtained by medical checkup or the like, such as height, weight, sex, blood pressure, body mass index (BMI), body fat percentage, neutral fat value, smoking status and amount, drinking status and amount, and the like of the subject. The clustering device 100 clusters the medical examination data including one or more of the above to output a cluster label indicating one of the multiple clusters. As the multiple clusters, for example, clusters related to age groups (young people, middle-aged people, elderly people, etc.) and clusters related to diseases and lifestyle diseases (hypertension, obesity type, hyperlipidemia, etc.) can be obtained. The clustering device 100 performs clustering based on the input medical examination data, and outputs a cluster label of the subject to the prediction device 50.

The prediction device 50 includes a prediction model prepared in advance for each cluster determined by the clustering device 100 described above. For example, in a case where the clustering device 100 performs clustering into three clusters 1 to 3, a prediction model 1 associated with the cluster 1, a prediction model 2 associated with the cluster 2, and a prediction model 3 associated with the cluster 3 are prepared in advance. Each prediction model includes a neural network, for example, and is trained to receive one or multiple pieces of medical examination data as an input and predict a disease risk for the input. For example, the prediction model is a model that receives inputs such as blood pressure, weight, body mass index (BMI), and the like as medical examination data and predicts the risk of heart disease. The prediction device 50 predicts and outputs a disease risk using the prediction models 1 to 3.

Upon input of medical examination data of a certain subject, the clustering device 100 performs clustering based on the input medical examination data, and outputs a cluster label of the subject to the prediction device 50. Next, the prediction device 50 predicts a disease risk from the medical examination data of the subject by using the prediction model associated with the input cluster label, and outputs the disease risk.

In the disease risk prediction device 200, even in a case where multimodal medical examination data including multiple pieces of data having different attributes is used, the clustering device 100 can identify a potential cluster having a unique property. As a result, a disease risk can be predicted using a prediction model suitable for the cluster, so that the disease risk can be predicted with high accuracy.

By presenting the disease risk predicted by this disease risk prediction device 200 to the subject, it is possible to assist the subject in making decisions such as changing health-related habits.

### Second Example Embodiment

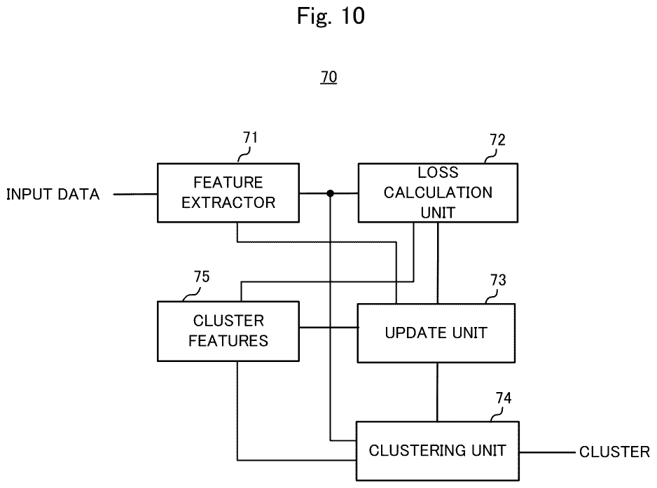

FIG. 10 is a block diagram illustrating a functional configuration of a clustering device of a second example embodiment. A clustering device 70 includes a feature extractor 71, a loss calculation unit 72, an update unit 73, and a clustering unit 74.

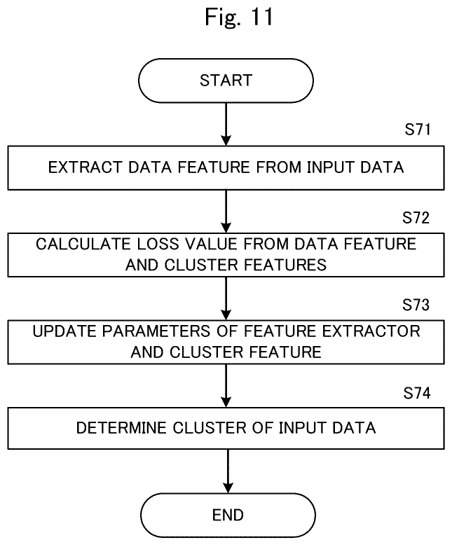

FIG. 11 is a flowchart of processing by the clustering device of the second example embodiment. The feature extractor 71 extracts a data feature from input data (step S71). The loss calculation unit 72 calculates a loss value that maximizes the similarity of the data feature to the nearest cluster feature 75 and minimizes the similarity of the data feature to the cluster features 75 other than the nearest cluster feature 75 (step S72). The update unit 73 updates the parameters of the feature extractor and the multiple cluster features 75 based on the loss value (step S73). The clustering unit 74 determines a cluster to which the input data belongs, based on the similarity between the data feature and the multiple cluster features 75 (step S74).

According to the clustering device 70 of the second example embodiment, it is possible to find a potential cluster having a unique property even in a complex data structure.

A part or all of the example embodiments described above may also be described as the following supplementary notes, but not limited thereto.

### (Supplementary Note 1)

A clustering device comprising:
a feature extractor that extracts a data feature from input data;
a loss calculation means configured to calculate a loss value that maximizes a similarity of the data feature to a nearest cluster feature and minimizes a similarity of the data feature to a cluster feature other than the nearest cluster feature;
an update means configured to update parameters of the feature extractor and a plurality of the cluster features based on the loss value; and
a clustering means configured to determine a cluster to which the input data belongs, based on the similarity between the data feature and the plurality of cluster features.

### (Supplementary Note 2)

The clustering device according to Supplementary note 1, wherein the loss calculation means converts the similarity between the data feature and the plurality of cluster features into a probability distribution, and calculates an entropy of the obtained probability distribution as the loss value.

### (Supplementary Note 3)

The clustering device according to Supplementary note 1, wherein
the feature extractor is a deep learning model, and
the update means performs a first update of updating the parameters of the feature extractor and a second update of updating the plurality of cluster features.

### (Supplementary Note 4)

The clustering device according to Supplementary note 3, wherein the second update updates each of the plurality of cluster features in such a way that the similarity of the cluster feature with other cluster features is reduced while the similarity of the cluster feature with a nearest data feature is maintained.

### (Supplementary Note 5)

The clustering device according to Supplementary note 3, wherein the update means performs the second update by using the data feature extracted by the feature extractor after the parameters are updated by the first update.

### (Supplementary Note 6)

The clustering device according to Supplementary note 3, wherein the update means repeats an update cycle including the first update and the second update a plurality of times.

### (Supplementary Note 7)

The clustering device according to Supplementary note 6, wherein the update means performs the first update and the second update using the same input data in the same update cycle.

### (Supplementary Note 8)

The clustering device according to Supplementary note 1, wherein initial values of the plurality of cluster features are set to random values.

### (Supplementary Note 9)

A clustering method executed by a computer, the clustering method comprising:
extracting a data feature from input data using a feature extractor;
calculating a loss value that maximizes a similarity of the data feature to a nearest cluster feature and minimizes a similarity of the data feature to a cluster feature other than the nearest cluster feature;
updating parameters of the feature extractor and a plurality of the cluster features based on the loss value; and
determining a cluster to which the input data belongs, based on the similarity between the data feature and the plurality of cluster features.

### (Supplementary Note 10)

A program causing a computer to execute:
extracting a data feature from input data using a feature extractor;
calculating a loss value that maximizes a similarity of the data feature to a nearest cluster feature and minimizes a similarity of the data feature to a cluster feature other than the nearest cluster feature;
updating parameters of the feature extractor and a plurality of the cluster features based on the loss value; and
determining a cluster to which the input data belongs, based on the similarity between the data feature and the plurality of cluster features.

Some or all of the configurations described in Supplementary Notes 2 to 8 dependent on the above-described Supplementary Note 1 can also be dependent on Supplementary Notes 9 and 10 by a dependency relationship similar to that of Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

11 Processor
21 Feature extractor
22 Loss calculation unit
23 Cluster feature group
24 Update unit
31 Clustering unit
100 Clustering device
200 Disease risk prediction device

1. A clustering device comprising:
a memory configured to store instructions; and
a processor configured to execute the instructions to:
extract a data feature from input data using a feature extractor, wherein the feature extractor is a deep learning model;
calculate a loss value based on a similarity between the data feature and a plurality of cluster features;
perform an update process based on the loss value by performing a plurality of update cycles, each update cycle comprising:
a first update of updating parameters of the feature extractor to increase a similarity of the data feature to a nearest cluster feature among the plurality of cluster features and decrease a similarity of the data feature to other cluster features; and
a second update of updating the plurality of the cluster features to decrease a similarity among the plurality of cluster features;
determine a cluster to which the input data belongs, based on the similarity between the data feature and the plurality of updated cluster features.

2. The clustering device according to claim 1, wherein the processor, in calculating the loss value, converts the similarity between the data feature and the plurality of cluster features into a probability distribution, and calculates an entropy of the obtained probability distribution as the loss value.

3. The clustering device according to claim 1, wherein the second update updates each of the plurality of cluster features in such a way that the similarity of the cluster feature with other cluster features is reduced while the similarity of the cluster feature with a nearest data feature is maintained.

4. The clustering device according to claim 1, wherein the processor performs the second update by using the data feature extracted by the feature extractor after the parameters of the feature extractor are updated by the first update.

5. The clustering device according to claim 1, wherein the processor performs the first update and the second update using a same input data within a same update cycle of the plurality of update cycles.

6. The clustering device according to claim 1, wherein initial values of the plurality of cluster features are set to random values.

7. A clustering method executed by a computer, comprising:
extracting a data feature from input data using a feature extractor, wherein the feature extractor is a deep learning model;
calculating a loss value based on a similarity between the data feature and a plurality of cluster features;
performing an update process based on the loss value by performing a plurality of update cycles, each update cycle comprising:
a first update of updating parameters of the feature extractor to increase a similarity of the data feature to a nearest cluster feature among the plurality of cluster features and decrease a similarity of the data feature to other cluster features; and
a second update of updating the plurality of the cluster features to decrease a similarity among the plurality of cluster features;
determining a cluster to which the input data belongs, based on the similarity between the data feature and the plurality of updated cluster features.

8. A non-transitory computer-readable recording medium storing a program, the program causing a computer to execute:
extracting a data feature from input data using a feature extractor, wherein the feature extractor is a deep learning model;
calculating a loss value based on a similarity between the data feature and a plurality of cluster features;
performing an update process based on the loss value by performing a plurality of update cycles, each update cycle comprising:
a first update of updating parameters of the feature extractor to increase a similarity of the data feature to a nearest cluster feature among the plurality of cluster features and decrease a similarity of the data feature to other cluster features; and
a second update of updating the plurality of the cluster features to decrease a similarity among the plurality of cluster features;
determining a cluster to which the input data belongs, based on the similarity between the data feature and the plurality of updated cluster features.
